(19) United States
(12) Patent Application Publication
(10) Pub. No.: US 2005/0041350 A1
(43) Pub. Date: Feb. 24, 2005

(54) Overvoltage protective circuit for a brushless DC motor

(75) Inventors: Alex Horng, Kaohsiung (TW); Ta-Lun Ko, Kaohsiung Hsien (TW)

Correspondence Address: BACON & THOMAS, PLLC, 625 SLATERS LANE, FOURTH FLOOR, ALEXANDRIA, VA, 22314, US

(73) Assignee: Sunonwealth Electric Machine Industry Co., Ltd., Kaohsiung (TW)

(21) Appl. No.: 10/661,538

(22) Filed: Sep. 15, 2003

(30) Foreign Application Priority Data
Aug. 22, 2003 (TW) 92123131

(51) Int. Cl. H02H 3/20

(52) U.S. Cl. 361/91.1

(57) ABSTRACT

An overvoltage protective circuit includes an overvoltage protective element, a first resistor, a second resistor, a first transistor and a second transistor. The overvoltage protective element is connected a power source to a motor drive circuit, and a ground line for discharging overvoltage. The first resistor is provided with a first voltage reference for the second transistor to turn it on or off. The first transistor is connected with the second transistor to constitute a switch set which is connected between the overvoltage protective element and the motor drive circuit so as to discharge overvoltage supplied from the power source. The second resistor is provided with a second voltage reference for the first transistor to turn it on or off. Supplying overvoltage from the power source, the overvoltage protective element actuates the second transistor to turn on for grounding overvoltage and turning off the first transistor so as to cut off the motor drive circui.

### BACKGROUND OF THE INVENTION

1. Field of the Invention

The present invention is related to an overvoltage protective circuit for a brushless dc motor. More particularly, the present invention is related to the overvoltage protective circuit for the brushless dc motor which simplifies the entire circuitry.

2. Description of the Related Art

A conventional current-limiting circuit for a brushless dc fan motor includes a first transistor, a second transistor, a first resistor and a second resistor which are connected and arranged in complementary. The current-limiting circuit has two terminals connected to a power source and a motor drive circuit.

When the voltage of the power source is rapidly increased, an end of the first resistor has an increase of voltage that turns on the first transistor. Synchronously, an end of the second resistor has a decrease of voltage that turns off the second transistor and cuts off the motor drive circuit. The first transistor and the second transistor are alternatively turned on until the voltage and current of the power source is regular.

Therefore, the current-limiting circuit is able to avoid great power consumption and operational heat when the fan motor is operated in abnormal or failed.

However, the current-limiting circuit is unsuitable for the use of protection of overvoltage for the brushless dc fan motor. Namely, the current-limiting circuit fails to have an overvoltage protective element and thus cannot be in response to overvoltage from the power supply precisely.

Hence, there is a need for an overvoltage protective circuit that effectively avoids supplying overvoltage to the brushless dc fan motor when overvoltage of the power supply is occurred.

The present invention intends to provide a brushless dc motor which employs an overvoltage protective circuit to avoid injecting overvoltage into it in such a way to mitigate and overcome the above problem.

### SUMMARY OF THE INVENTION

The primary objective of this invention is to provide an overvoltage protective circuit for a brushless dc motor, which has a simplified circuitry, connected to a motor drive circuit. Thereby, the brushless dc motor can prolong its useful life.

The secondary objective of this invention is to provide the overvoltage protective circuit for the brushless dc motor, which has a simplified circuitry, to simplify its entire structure.

The overvoltage protective circuit for the brushless dc motor in accordance with the present invention includes an overvoltage protective element, a first resistor, a second resistor, a first transistor and a second transistor. The overvoltage protective element is connected a power source to a motor drive circuit, and a ground line for discharging overvoltage supplied from the power source. The first resistor is provided with a first voltage reference for the second transistor to turn it on or off. The first transistor is connected with the second transistor to constitute a switch set which is connected between the overvoltage protective element and the motor drive circuit so as to discharge overvoltage supplied from the power source. The second resistor is provided with a second voltage reference for the first transistor to turn it on or off. Supplying overvoltage from the power source, the overvoltage protective element actuates the second transistor to turn on for grounding overvoltage and turning off the first transistor so as to cut off the motor drive circuit from the power source.

Other objectives, advantages and novel features of the invention will become more apparent from the following detailed description and the accompanying drawings.

### BRIEF DESCRIPTION OF THE DRAWINGS

The present invention will now be described in detail with reference to the accompanying drawings herein:

FIG. 1 is a schematic circuitry of an overvoltage protective circuit for a brushless dc motor in accordance with a first embodiment of the present invention; and

FIG. 2 is a schematic circuitry of an overvoltage protective circuit for a brushless dc motor in accordance with a second embodiment of the present invention.

### DETAILED DESCRIPTION OF THE INVENTION

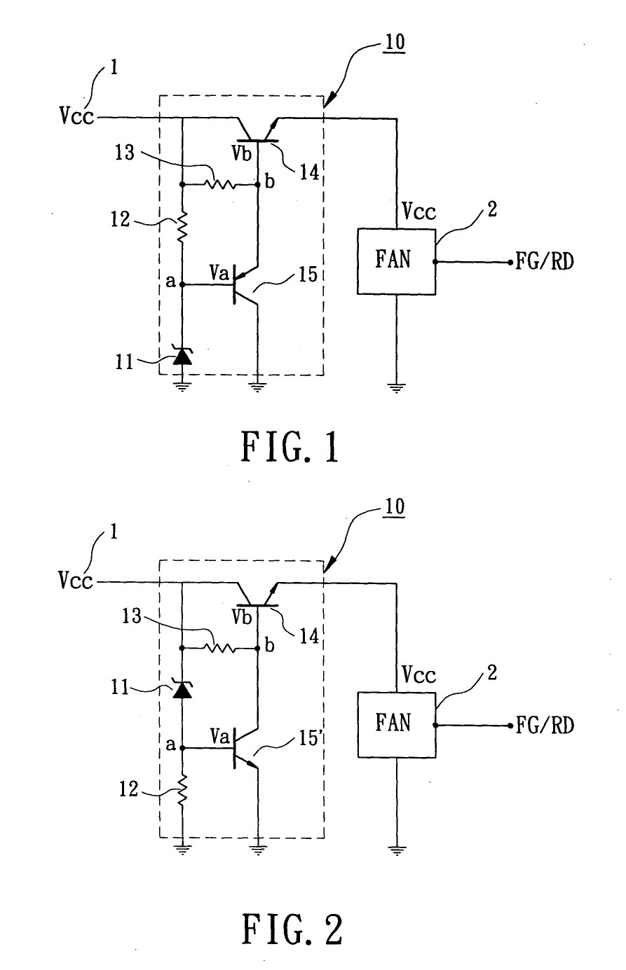

Referring initially to FIGS. 1 and 2, the present invention generally includes a fan motor member designated numeral 2 and an overvoltage protective circuit member designated numeral 10.

FIG. 1 illustrates schematic circuitry of an overvoltage protective circuit for a brushless dc motor in accordance with a first embodiment of the present invention. Referring to FIG. 1, the overvoltage protective circuit 10 is connected between a power source (Vcc) 1 and a motor drive circuit 2. The overvoltage protective circuit 10 is essentially consisted of an overvoltage protective element 11, a first resistor 12, a second resistor 13, a first transistor 14 and a second transistor 15.

Referring again to FIG. 1, the overvoltage protective element 11 is serially connected to the first resistor 12 at a common point (a) to form a combination which is connected between the power source 1 and a ground line so as to discharge overvoltage supplied from the power source 1. Preferably, the overvoltage protective element 11 is a zener diode. To discharge overvoltage, the power supply 1 connects to the ground line via the overvoltage protective element 11 and the first resistor 12.

In operation, the first resistor 12 is provided with a first voltage reference Va for controlling the second transistor 15 to turn on or off. When overvoltage results in a discharge of the overvoltage protective element 11 to the ground line, current flowing through the first resistor 12 provides the first voltage reference Va at the common point (a).

Furthermore, the first transistor 14 is connected to the second transistor 15 to constitute a switch set. The first transistor 14 has a base connected to the second transistor 15. Preferably, the second transistor 15 is a PNP transistor which has an emitter connected to the base of the first transistor 14, and a base connected to the common point (a). Consequently, the combination of the overvoltage protective element 11 and the first resistor 12 is able to control the first voltage reference Va for turning on or off the second transistor 15. Turning on or off the second transistor 15 can control to turn on or off the first transistor 14. The switch set of the first transistor 14 and the second transistor 15 is connected between the combination of the overvoltage protective element 11 and the first resistor 12 and the motor drive circuit 2, thereby limiting overvoltage supplied from the power source 1. The second resistor 13 is connected to a common point (b) located between the base of the first transistor 14 and the emitter of the second transistor 15, and provided with a second voltage reference Vb for controlling the first transistor 14 to turn on or off. The first transistor 14 allows the voltage of the power supply 1 passing to motor drive circuit 2. Alternatively, the first transistor 14 cuts off the voltage of the power supply 1 passing to motor drive circuit 2 and the power supply 1 may be connected to the ground line via the second resistor 13 and the second transistor 15.

Referring again to FIG. 1, when the power source 1 has supplied a normal voltage, the first voltage reference Va supplied from the power source 1 at the end of the first resistor 12 is inadequate to conduct the overvoltage protective element 11 to discharge to the ground line. Also, the first voltage reference Va at the end of the first resistor 12 is regarded as a Hi level, and thus it fails to turn on the base of the second transistor (PNP transistor) 15 which is unsaturated. Simultaneously, the second voltage reference Vb supplied from the power source 1 at the end of the second resistor 13 is regarded as a Hi level and adequate to turn on the base of the first transistor (NPN transistor) 14. Consequently, turning on the first transistor 14 allows the power source 1 to supply to the motor drive circuit 2.

When the power source 1 has supplied an overvoltage, the first voltage reference Va supplied from the power source 1 at the end of the first resistor 12 is rapidly increased to conduct the overvoltage protective element 11 to the ground line. Once the overvoltage protective element 11 is breakdown, it is discharged the power source 1 to the ground line. Current flowing through the first resistor 12 provides the first voltage reference Va at its end. By contrast, the first voltage reference Va is changed to a Lo level, and thus it is able to turn on the base of the second transistor (PNP transistor) 15 which may be saturated. Simultaneously, as the second transistor 15 is turned on, current flowing through the second resistor 13 provides the second voltage reference Vb at its end. By contrast, the second voltage reference Vb is changed to a Lo level, and inadequate to turn on the base of the first transistor (NPN transistor) 14. Consequently, turning off the first transistor 14 cuts off the power source 1 to supply to the motor drive circuit 2.

When the overvoltage supplied from the power source 1 has been removed, the voltage of the power source 1 may be decreased. Once the first voltage reference Va supplied from the power source 1 is lower than a breakdown voltage of the overvoltage protective element 11, the overvoltage protective element 11 is turned off to discharge to the ground line. Also, the first voltage reference Va at the end of the first resistor 12 is changed to a Hi level, and thus it fails to turn on the base of the second transistor (PNP transistor) 15. Simultaneously, the second voltage reference Vb supplied from the power source 1 at the end of the second resistor 13 is changed to a Hi level and adequate to turn on the base of the first transistor (NPN transistor) 14. Consequently, turning on the first transistor 14 allows the power source 1 to re-supply to the motor drive circuit 2.

FIG. 2 illustrates schematic circuitry of an overvoltage protective circuit for a brushless dc motor in accordance with a second embodiment of the present invention.

Referring to FIG. 2, reference numerals of the second embodiment has applied the identical numerals of the overvoltage protective circuit of the first embodiment. The overvoltage protective circuit of the second embodiment has the similar configuration and same function as that of the first embodiment and the detailed descriptions are omitted.

Referring to FIG. 2, the overvoltage protective circuit 10 is connected between a power source (Vcc) 1 and a motor drive circuit 2. The overvoltage protective circuit 10 is essentially consisted of an overvoltage protective element 11, a first resistor 12, a second resistor 13, a first transistor 14 and a second transistor 15′.

In comparison with the first embodiment, the second transistor 15′ is a NPN transistor. The combination of the overvoltage protective element 11 and the first resistor 12 is able to control the first voltage reference Va for turning on or off the base of the second transistor 15′.

Referring again to FIG. 2, when the power source 1 has supplied a normal voltage, the first voltage reference Va supplied from the power source 1 at the end of the first resistor 12 is inadequate to conduct the overvoltage protective element 11 to discharge to the ground line. Also, the first voltage reference Va at the end of the first resistor 12 is regarded as a Lo level, and thus it fails to turn on the base of the second transistor (NPN transistor) 15′ which is unsaturated. Simultaneously, the second voltage reference Vb supplied from the power source 1 at the end of the second resistor 13 is regarded as a Hi level and adequate to turn on the base of the first transistor (NPN transistor) 14. Consequently, turning on the first transistor 14 allows the power source 1 to supply to the motor drive circuit 2.

When the power source 1 has supplied an overvoltage, the voltage is greater than the breakdown voltage of the overvoltage protective element 11 and conducts it to discharge to the ground line. Current flowing through the first resistor 12 provides the first voltage reference Va at its end. By contrast, the first voltage reference Va is changed to a Hi level, and thus it is able to turn on the base of the second transistor (NPN transistor) 15′ which may be saturated. Simultaneously, as the second transistor 15′ is turned on, current flowing through the second resistor 13 provides the second voltage reference Vb at its end. By contrast, the second voltage reference Vb is changed to a Lo level, and inadequate to turn on the base of the first transistor (NPN transistor) 14. Consequently, turning off the first transistor 14 cuts off the power source 1 to supply to the motor drive circuit 2.

When the overvoltage supplied from the power source 1 has been removed, the voltage of the power source 1 may be decreased. Once the voltage supplied from the power source 1 is lower than a breakdown voltage of the overvoltage protective element 11, the overvoltage protective element 11 is turned off to discharge to the ground line. Also, the first voltage reference Va at the end of the first resistor 12 is changed to a Lo level, and thus it fails to turn on the base of the second transistor (NPN transistor) 15′. Simultaneously, the second voltage reference Vb supplied from the power source 1 at the end of the second resistor 13 is changed to a Hi level and adequate to turn on the base of the first transistor (NPN transistor) 14. Consequently, turning on the first transistor 14 allows the power source 1 to re-supply to the motor drive circuit 2.

Although the invention has been described in detail with reference to its presently preferred embodiment, it will be understood by one of ordinary skill in the art that various modifications can be made without departing from the spirit and the scope of the invention, as set forth in the appended claims.

1. An overvoltage protective circuit for a brushless dc motor, comprising:
an overvoltage protective element connected between a power source and a motor drive circuit, the overvoltage protective element being further connected between the power source and a ground line, and thus adapted to discharge overvoltage supplied from the power source;
a first resistor serially connected to the overvoltage protective element and adapted to provide a first voltage reference;
a first transistor having a base, the first transistor being connected in series between the power source and the motor drive circuit and adapted to cut off the motor drive circuit from the power source;
a second transistor connected to the first transistor to constitute a switch set, the second transistor having a base connected to the first resistor so that the first voltage reference of the first resistor is able to control turning on or off the second transistor; and
a second resistor connected between the power source and the first transistor, and adapted to provide a second voltage reference so that the second voltage reference of the second resistor is able to control turning on or off the first transistor;
wherein when the power supply has supplied a normal voltage, the overvoltage protective element is does not conduct to discharge the power source to the ground line, the first voltage reference of the first resistor is able to turn off the second transistor, and the second voltage reference of the second resistor is able to turn on the first transistor that allows the power supply to supply power to the motor drive circuit; and
wherein when the power supply has supplied an overvoltage, the overvoltage protective circuit is conducts to discharge the overvoltage to the ground line, the first voltage reference of the first resistor is able to turn on the second transistor for grounding, and the second voltage reference of the second resistor is able to turn off the first transistor that cuts off the power supply to the motor drive circuit.

2. The overvoltage protective circuit for the brushless dc motor as defined in claim 1, wherein the overvoltage protective element is a zener diode.

3. The overvoltage protective circuit for the brushless dc motor as defined in claim 1, wherein the second transistor is a PNP transistor.

4. The overvoltage protective circuit for the brushless dc motor as defined in claim 1, wherein the second transistor is an NPN transistor.

5. The overvoltage protective circuit for the brushless dc motor as defined in claim 1, wherein the overvoltage protective element is serially connected to the first resistor at a common point which is connected to the base of the second transistor so as to supply the first voltage reference to the base of the second transistor.

6. The overvoltage protective circuit for the brushless dc motor as defined in claim 1, wherein the first transistor and the second transistor are formed with a common point which is connected to the second resistor so as to supply the second voltage reference to the base of the first transistor.
